(19) United States
(12) Patent Application Publication
(10) Pub. No.: US 2006/0070200 A1
(43) Pub. Date: Apr. 6, 2006

(54) Wiper device attached using plate-shaped lever or lever having a bent portion

(75) Inventors: Tomohiro Ohe, Shioya-gun (JP); Mamoru Kagawa, Kawachi-gun (JP)

Correspondence Address: CARRIER BLACKMAN AND ASSOCIATES, 24101 NOVI ROAD, SUITE 100, NOVI, MI, 48375, US

(73) Assignee: Honda Motor Co., Ltd., Tokyo (JP)

(21) Appl. No.: 11/236,685

(22) Filed: Sep. 27, 2005

(30) Foreign Application Priority Data
Oct. 1, 2004 (JP) 2004-289922

(51) Int. Cl. B60S 1/24

(52) U.S. Cl. 15/250.3; 15/250.31; 15/250.351

(57) ABSTRACT

A wiper device includes a linking member to which a driving force is transmitted via a wiper motor; a rotating shaft fastened to the linking member; a lever portion, one end of which is fastened to the rotating shaft, wherein the lever portion is a plate member laid down in a plane in which the lever portion is rotated, and the lever portion has a bent portion which is bent toward an axis of the rotating shaft; and a wiper arm coupled with the other end of the lever member. The wiper device may further comprise a coupling shaft disposed parallel to the rotating shaft, wherein the other end of the lever portion is fastened via the coupling shaft to the wiper arm, and is closer to the wiper arm than said one end in an axial direction of the coupling shaft.

### BACKGROUND OF THE INVENTION

1. Field of the Invention

The present invention relates to a wiper device which can absorb an impact applied from the outside.

Priority is claimed on Japanese Patent Application No. 2004-289922, filed Oct. 1, 2004, the content of which is incorporated herein by reference.

1. Description of the Related Art

In an example of a wiper device, a pivot shaft is supported by a pivot holder in a freely rotatable form, a base end of a wiper arm is fastened to a protruding end of the pivot shaft, and a wiper blade is attached to a rotating end of the wiper arm in a freely rockable form, so that the wiper blade can wipe a front windowpane or the like.

In such a wiper device, the wiper blade and the wiper arm are positioned at the outside of the front windowpane, and an end of the pivot shaft to which the wiper arm is fastened protrudes from an outer surface of the vehicle body, so that this structure tends to be subjected to an external force. In order to reduce damage on the vehicle body due to an impact load, a structure for absorbing the impact has been developed (see Japanese Unexamined Patent Application, First Publication No. H11-048917).

However, in the above conventional technique, any impact is absorbed by detaching a holder portion (for attaching the pivot shaft to the vehicle body) of the pivot holder; thus, rigidity of the holder portion attached to the vehicle body is degraded, and thus necessary rigidity of the pivot shaft attached to the vehicle body cannot be secured.

### SUMMARY OF THE INVENTION

In light of the above circumstances, an object of the present invention is to provide a wiper device having superior impact absorbing performance while providing sufficient rigidity to the wiper device attached to the vehicle body.

Therefore, the present invention provides a wiper device comprising:

a linking member (e.g., a link 52 in an embodiment explained later) to which a driving force is transmitted via a wiper motor (e.g., a wiper motor 46 in the embodiment);

a rotating shaft (e.g., a pivot shaft 6 in the embodiment) fastened to the linking member;

a lever portion (e.g., an actuating lever 15 in the embodiment), one end of which is fastened to the rotating shaft, wherein the lever portion is a plate member laid down in a plane in which the lever portion is rotated; and

a wiper arm (e.g., a wiper arm 24 in the embodiment) coupled with the other end of the lever member.

According to the above structure, it is possible to secure necessary rigidity with respect to a driving force applied in the rotating direction of the lever portion, and when an impact load is applied from the outside of the vehicle, the lever portion can deform so as to absorb the impact. Therefore, rigidity of the attached rotating shaft does not relate to impact absorption. Accordingly, in comparison with a structure for absorbing an impact by detaching the rotating shaft, higher rigidity can be provided to the wiper device attached to the vehicle body.

The present invention also provides a wiper device comprising:

a linking member to which a driving force is transmitted via a wiper motor;

a rotating shaft fastened to the linking member;

a lever portion, one end of which is fastened to the rotating shaft, wherein the lever portion has a bent portion (e.g., a first bent portion 15D and a second bent portion 15E in the embodiment) which is bent toward an axis of the rotating shaft; and

a wiper arm coupled with the other end of the lever member.

According to the above structure, when an impact load is applied from the outside of the vehicle, the lever portion can deform around the bent portion so as to absorb the impact, thereby reliably absorbing the impact.

The present invention also provides a wiper device comprising:

a linking member to which a driving force is transmitted via a wiper motor;

a rotating shaft fastened to the linking member;

a lever portion, one end of which is fastened to the rotating shaft, wherein the lever portion is a plate member laid down in a plane in which the lever portion is rotated, and the lever portion has a bent portion which is bent toward an axis of the rotating shaft; and

a wiper arm coupled with the other end of the lever member.

According to the above structure, it is possible to secure necessary rigidity with respect to a driving force applied in the rotating direction of the lever portion, and when an impact load is applied from the outside of the vehicle, the lever portion can deform around the bent portion so as to absorb the impact, thereby reliably absorbing the impact. Therefore, rigidity of the attached rotating shaft does not relate to impact absorption, and in comparison with a structure for absorbing an impact by detaching the rotating shaft, higher rigidity can be provided to the wiper device attached to the vehicle body.

The wiper device in which the lever portion has the bent portion may further comprise a coupling shaft disposed parallel to the rotating shaft, wherein the other end of the lever portion may be fastened via the coupling shaft to the wiper arm, and may be closer to the wiper arm than said one end in an axial direction of the coupling shaft. Accordingly, the length of the coupling shaft can be made smaller, and shaking of a portion for supporting the wiper arm can be suppressed, thereby smoothly performing the wiping operation of the wiper arm.

### BRIEF DESCRIPTION OF THE DRAWINGS

FIG. 1 is a perspective view showing a front portion of a vehicle to which a wiper device as an embodiment of the present invention is attached.

FIG. 2 is a perspective view omitting a hood and an upper cowl top garnish in FIG. 1.

FIG. 3 is a perspective view of the second wiper device so as to show an operating state thereof.

FIG. 4 is a perspective view of a distinctive portion in FIG. 2.

FIG. 5 is a perspective view of a portion around the front windowpane.

FIG. 6 is an enlarged view of a distinctive portion in FIG. 2.

FIG. 7 is a front view of the linking device.

FIG. 8 is a plan view of the linking device.

FIG. 9 is a diagram viewed in a direction indicated by the arrow A in FIG. 7.

FIG. 10 is a perspective exploded view showing a distinctive portion of the embodiment.

### DETAILED DESCRIPTION OF THE INVENTION

Hereinafter, embodiments according to the present invention will be described with reference to the appended figures.

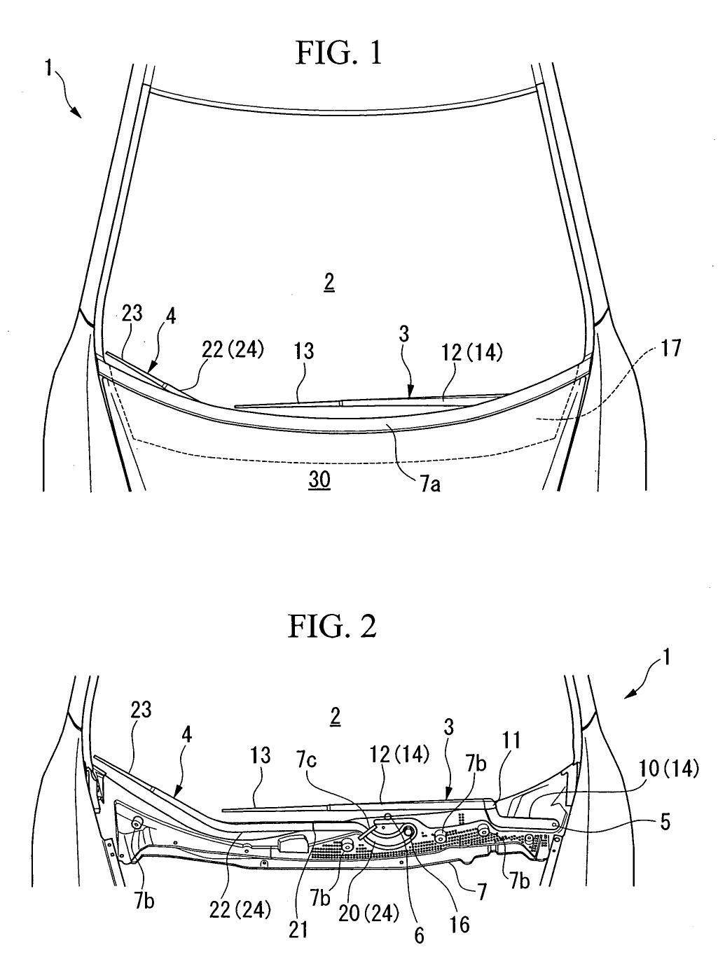

FIG. 1 is a perspective view showing a front portion of a vehicle to which a wiper device as an embodiment of the present invention is attached. FIG. 2 is a perspective view omitting a hood and an upper cowl top garnish in FIG. 1.

As shown in FIGS. 1 and 2, a vehicle 1 has first and second wiper devices 3 and 4, respectively, for wiping a front windowpane 2. Wiping operations of the wiper devices 3 and 4 are performed using a pivot shaft 5 which rotates via a wiper motor 46 (explained later), and a pivot shaft 6 (i.e., a rotating shaft of the present invention). The first wiper device 3, positioned on the vehicle's left side, has a pivot shaft 5 disposed at the left end thereof. The pivot shaft 5 protrudes from a cowl top garnish 7 which is arranged under the front windowpane 2 in the width direction of the vehicle. An arm base 10 is attached to the pivot shaft 5, and a shank 12 is supported via a hinge 11 at the arm base 10 in a manner such that the shank 12 can rise elastically. A wiper blade 13 is supported at the head of the shank 12 in a freely rockable form. The arm base 10 and the shank 12 constitute a wiper arm 14 of the first wiper device 3.

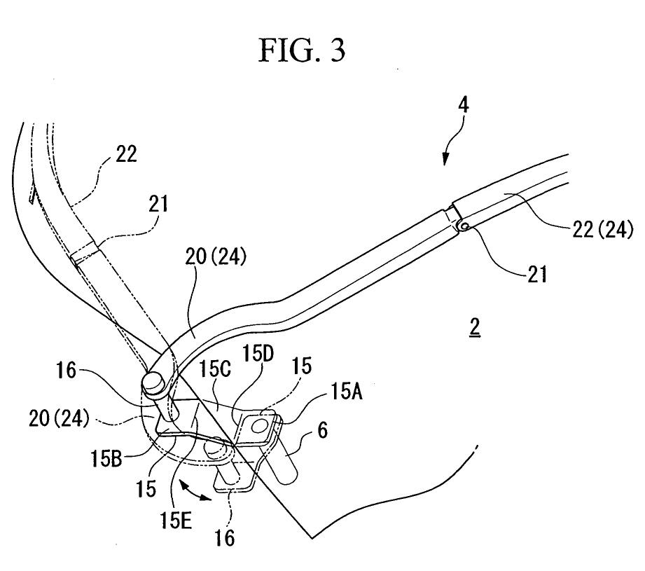

The second wiper device 4 is provided at the vehicle's right side. FIG. 3 is a perspective view of the second wiper device 4 so as to show an operating state thereof. As shown in FIG. 3, the second wiper device 4 has an actuating lever 15 (i.e., a lever portion), an end of which is fastened to the pivot shaft 6, and the actuating lever 15 is freely rotatable around the pivot shaft 6. To a rotating end of the actuating lever 15, a support shaft 16 (i.e., a coupling shaft) is fastened, which protrudes upward. This support shaft 16 moves describing an arc, together with the rotating end of the actuating lever 15 which rotates around the pivot shaft 6 (as the center axis). The support shaft 16 is positioned slightly toward the left from the center of the vehicle body. To the support shaft 16, an arc arm base 20 is fastened, which has a form conformable to the arc movement locus of the support shaft 16.

A shank 22 is supported via a hinge 21 at the head of the arc arm base 20 in a manner such that the shank 22 can rise elastically. A wiper blade 23 is supported at the head of the shank 22 in a freely rockable form. The arc arm base 20 and the shank 22 constitute a wiper arm 24 of the second wiper device 4.

An upper cowl top garnish 7a is provided so as to cover a base portion of the wiper arm 14 of the first wiper device 3, and also to cover a base portion of the wiper arm 24 of the second wiper device 4 together with the actuating lever 15. The upper cowl top garnish 7a is attached to attachment portions 7b of the cowl top garnish 7.

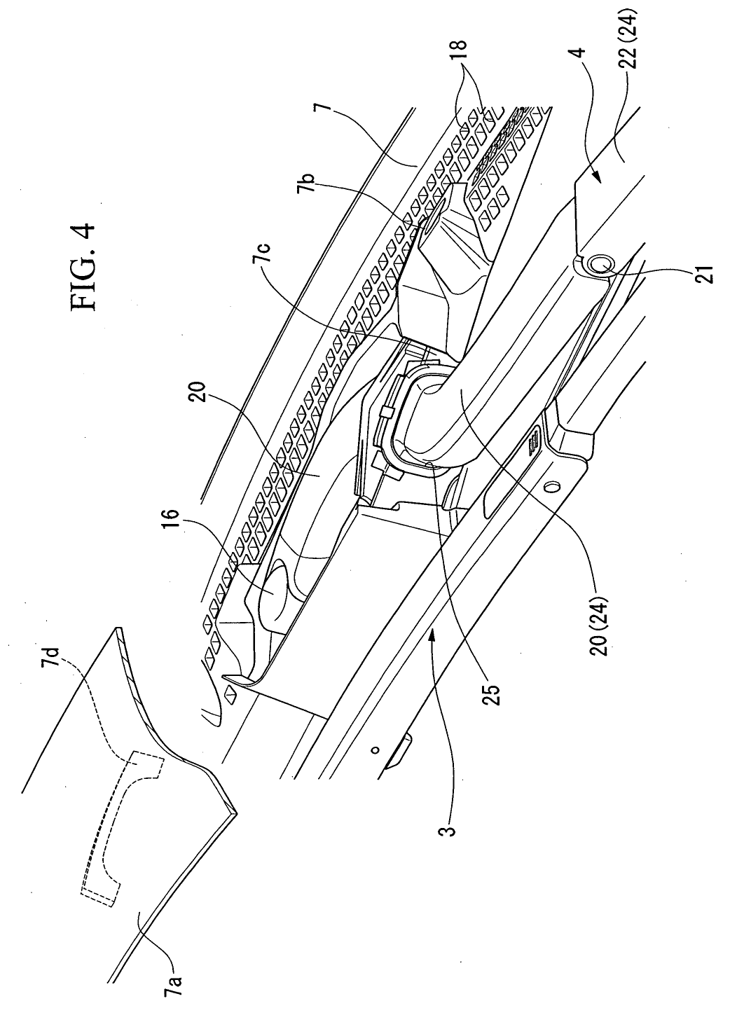

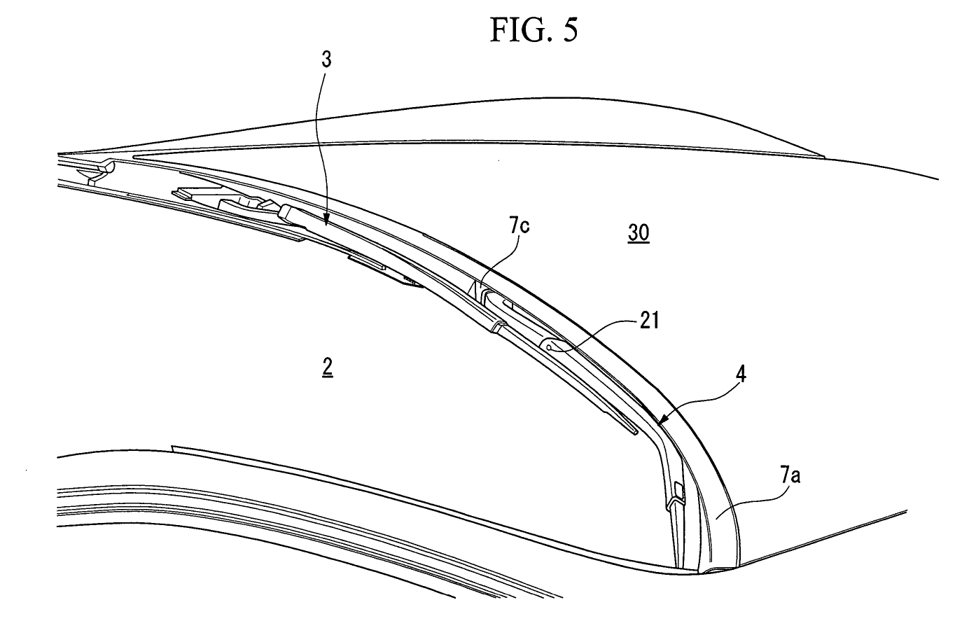

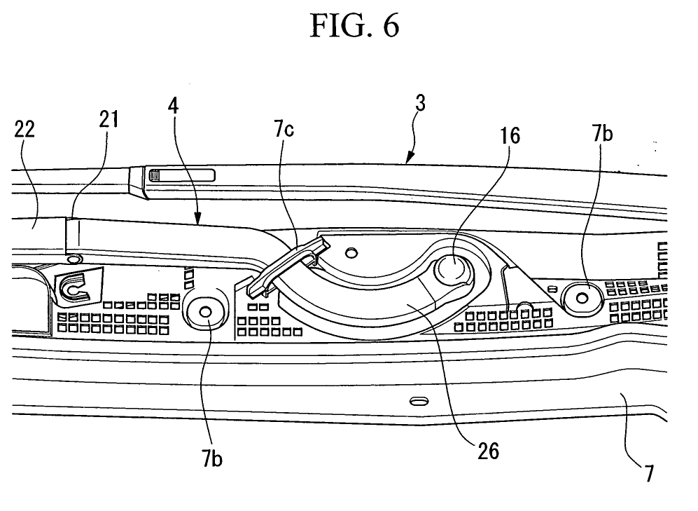

FIG. 4 is a perspective view of a distinctive portion in FIG. 2. FIG. 5 is a perspective view of a portion around the front windowpane 2. FIG. 6 is an enlarged view of a distinctive portion in FIG. 2.

As shown in FIGS. 4 to 6, the cowl top garnish 7 and the upper cowl top garnish 7a which is attached thereto are resin members arranged between a lower portion of the front windowpane 2 and a rear edge of a hood 30 in the width direction of the vehicle, and constitute an upper wall of a cowl box 17 shown in FIG. 1. In the upper face of the cowl top garnish 7, a number of holes 18 are formed so as to draw rainwater inward, and this rainwater is guided to both sides of the cowl box 17 and discharged.

In addition, outside air, drawn through the holes 18, is guided to an outside air introducing inlet provided in the cowl box 17. The upper cowl top garnish 7a is attached to an upper portion of the cowl top garnish 7, so as to cover base portions of the wiper devices 3 and 4 and also to cover the holes 18.

A vertical wall member 7c is detachably attached between the cowl top garnish 7 and the upper cowl top garnish 7a. In the vertical wall member 7c, a work hole 25 is provided, through which the arc arm base 20 of the second wiper device 4 passes. As shown in FIG. 4, on the back face of the upper cowl top garnish 7a, a pressing member 7d for pressing the vertical wall member 7c to a target position is provided.

The first wiper device 3 and the second wiper device 4 have a linking device 40 for actuating the pivot shafts 5 and 6 in synchronism with each other.

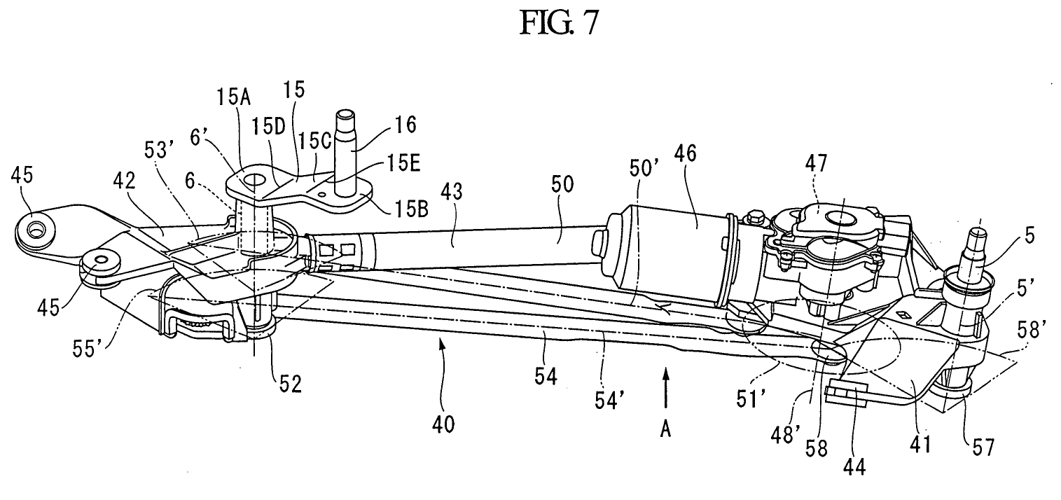

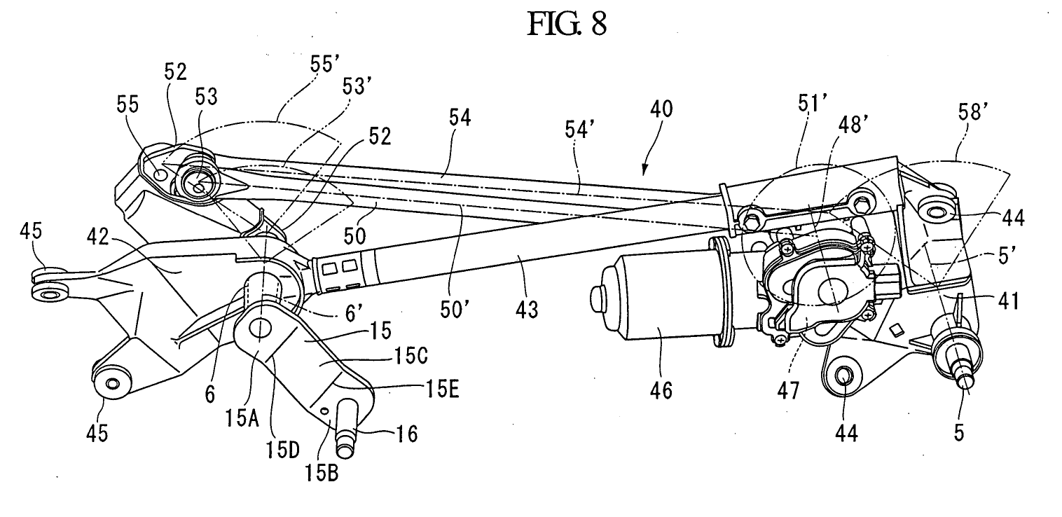

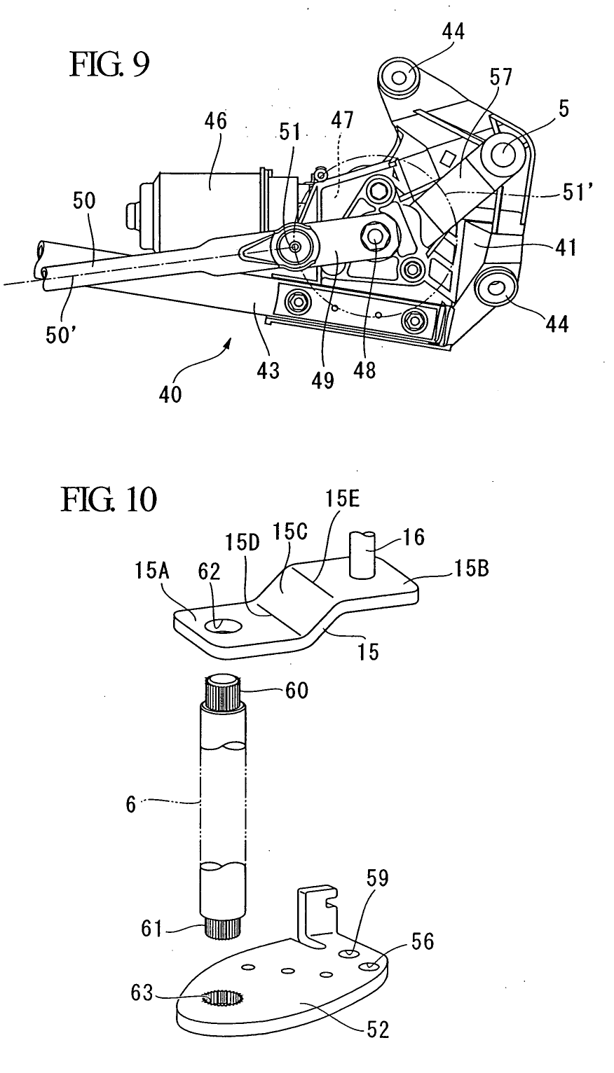

FIG. 7 is a front view of the linking device 40, and FIG. 8 is a plan view of the linking device. FIG. 9 is a diagram viewed in a direction indicated by the arrow A in FIG. 7. FIG. 10 is a perspective exploded view showing a distinctive portion of the present embodiment.

As shown in FIGS. 7 to 10, the linking device 40 has a motor bracket 41 provided on the vehicle's left side, and a bracket 42 close to the center of the vehicle body. The motor bracket 41 and the bracket 42 are coupled and fixed to each other via a support rod 43. The motor bracket 41 has attachment seatings 44, and the bracket 42 has attachment seatings 45. Due to the attachment seatings 44 and 45, the wiper devices 3 and 4 can be reliably fastened via the linking device 40 to the vehicle body with high rigidity. The pivot shaft 5 is supported at the motor bracket 41 in a freely rotatable form, and the pivot shaft 6 is supported at the bracket 42 in a freely rotatable form. At the motor bracket 41, a wiper motor 46 and a speed reducer 47 which links therewith are provided. As shown in FIG. 9, to a rotating output shaft 48 of the speed reducer 47, a base end of a drive link 49 is fastened, and at a rotating end of the drive link 49, an end of a rod 50 is supported via a pin 51 in a freely rotatable form.

At the bracket 42, a base end of a link 52 (i.e., a linking member) is fastened to a lower end of the pivot shaft 6. At a rotating end of the link 52, the other end of the rod 50 is supported via a pin 53 in a freely rotatable form. In FIG. 10, reference numeral 56 indicates a support hole for the pin 53.

In the vicinity of the rotating end of the link 52, more specifically, in the vicinity of the position where the pin 53 is attached, an end of a rod 54 is supported via a pin 55 in a freely rotatable form. In FIG. 10, reference numeral 59 indicates a support hole for the pin 55. As shown in FIG. 7, the other end of the rod 54 is supported via a pin 58 at a rotating end (not shown) of a link 57 (shown in FIG. 9) in a freely rotatable form. The base end of the link 57 is fastened to the lower end of the pivot shaft 5.

As shown in FIG. 10, an end of the actuating lever 15 is fastened to the upper end of the pivot shaft 6, and the support shaft 16 is attached to the other end of the actuating lever 15. The arc arm base 20 of the wiper arm 24 is attached to the support shaft 16.

In FIGS. 7 to 9, in order to help in understanding of the cooperating relationships between structural members, reference numerals 5′ and 6′ respectively indicate axes of the pivot shafts 5 and 6, reference numeral 50′ indicates an axis of the rod 50, reference numeral 54′ indicates an axis of the rod 54, and reference numeral 48′ indicates an axis of the rotating output shaft 48. In addition, reference numeral 51′ indicates a rotation locus of the pin 51, and reference numerals 53′, 55′, and 58′ respectively indicate rotation loci of the pins 53, 55, and 58.

Therefore, when the wiper motor 46 is driven, the rotating output shaft 48 is rotated via the speed reducer 47 around the axis 48′, so that the pin 51 at the rotating end of the drive link 49 moves along the rotation locus 51′. Accordingly, the rod 50 performs a reciprocating motion substantially along the axis 50′, so that in the link 52, the pin 53 performs a reciprocating rotating motion along the rotation locus 53′ around the axis 6′ of the pivot shaft 6 (as the center of rotation). Accordingly, the pivot shaft 6 fastened to the base end of the link 52 performs a rotating motion, and the support shaft 16 at the above-described other end of the actuating lever 15 performs a rotating motion, so that the wiper device 4 fastened to the actuating lever 15 performs a wiping operation.

In addition, when the link 52 performs a rotating motion, the rod 54, supported by the pin 55 which performs a reciprocating motion along the rotation locus 55′, performs a reciprocating motion substantially along the axis 54′, so that in the link 57, the pin 58 performs a reciprocating rotating motion along the rotation locus 58′ around the axis 5′ of the pivot shaft 5 (as the center of rotation). Accordingly, the pivot shaft 5 fastened to the base end of the link 57 performs a rotating motion, so that the wiper device 3 fastened to the pivot shaft 5 performs a wiping operation.

As shown in FIG. 10, at upper and lower ends of the pivot shaft 6, serrated portions 60 and 61 are respectively formed. The upper serrated portion 60 is formed by knurling in which the number of teeth is set to 54. The lower serrated portion 61 is formed by a male involute serrating process in which the number of teeth is set to 24, that is, smaller than the number (54) of teeth of the upper serrated portion 60. The above numbers of teeth for the upper and lower serrated portions 60 and 61 are examples and can be freely selected. However, preferably, the number of teeth for the lower serrated portion 61 is smaller than that for the upper serrated portion 60.

The actuating lever 15 is a thick plate member made of metal, laid down in a plane in which the lever 15 is rotated. An end of the actuating lever 15 has a lower face 15A, and the other end has an upper face 15B. The lower and upper faces 1SA and 15B are coupled with each other via a slope 15C. That is, the actuating lever 15 is a crank-shaped member bent toward the axis of the pivot shaft 6.

More specifically, a first bent portion 15D is formed between the lower face 15A and the slope 15C, and a second bent portion 15E is formed between the slope 15C and the upper face 15B, so that the upper face 15B is higher than the lower face 15A. On the upper face 15B (in the above-described other end of the actuating lever 15), the support shaft 16, which is parallel to the pivot shaft 6, is clamped and fastened so as not to rotate, and the wiper arm 24 is fastened to the head of the support shaft 16. Accordingly, the upper face 15B of the actuating lever 15, to which the support shaft 16 is attached, is closer to the wiper arm 24 than the lower face 15A to which the pivot shaft 6 is attached.

A round hole 62 is formed at an end of the actuating lever 15, and a groove receiving portion 63 is formed at the base end of the link 52. The inner periphery of the groove receiving portion 63 is subjected to a female involute serrating process in which the number of teeth is set to 24, in advance.

The upper serrated portion 60 is pressed into and fastened to the round hole 62 of the actuating lever 15. The lower serrated portion 61 is fit to the groove receiving portion 63 of the link 52, and an end of the lower serrated portion 61 is clamped and fastened. The upper and lower serrated portions 60 and 61 may be tapered.

According to the above embodiment, when the pivot shaft 6 is rotated, a driving force is applied to the actuating lever 15 in the rotating direction. However, the actuating lever 15 is a plate member laid down in a plane in which the lever 15 is rotated; thus, necessary rigidity can be provided to the actuating lever 15. In addition, when an impact load imposed downward via the upper cowl top garnish 7a from the outside of the vehicle is applied to the support shaft 16 or the actuating lever 15, the actuating lever 15 can deform so as to absorb the impact. Therefore, in comparison with a conventional case of absorbing an impact by detaching the pivot shaft, an impact can be reliably absorbed while sufficient rigidity can be provided to the attached pivot shaft by using the attachment seatings 44 and 45 of the motor bracket 41 and the bracket 42, thereby reducing damage to the vehicle as much as possible.

The actuating lever 15 has the first bent portion 15D and the second bent portion 15E, which are bent toward the axis of the pivot shaft 6; thus, when an impact load is applied from the outside of the vehicle, deformation can be flexibly performed. For example, in a sectional view, (i) the slope 15C may be rotated (i.e., deformed) around the first bent portion 15D so as to increase the angle formed by the lower face 15A and slope 15C, or (ii) the upper face 15B may be rotated (i.e., deformed) around the second bent portion 15E so as to decrease the angle formed by the slope 15C and the upper face 15B. Therefore, any impact can be reliably absorbed. In particular, the upper face 15B of the actuating lever 15 is positioned higher than the lower face 15A by a height of the slope 15C; thus, downward displacement of the upper face 15B (positioned at the head side of the actuating lever 15) can be larger.

In addition, the upper face 15B, to which the support shaft 16 is attached, is positioned close to the wiper arm 24 due to the slope 15C (which is connected via the first bent portion 15D to the lower face 15A); thus, in comparison with a case of attaching the support shaft 16 to a position having the same height as that of the lower face 15A of the actuating lever 15, the length of the support shaft 16 can be made smaller. Therefore, bending of the support shaft 16 is reduced and shaking of a portion for supporting the wiper arm 24 can be suppressed, thereby smoothly performing the wiping operation of the wiper arm 24.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

For example, the wiper device 3 and a rear wiper device may have a structure similar to that of the wiper device 4.

Regarding the bent portion formed in the actuating lever 15, another bent portion may be provided in addition to the first bent portion 15D and the second bent portion 15E.

In the above embodiment, the actuating lever 15 is a plate member having the first bent portion 15D and the second bent portion 15E. However, the object of the present invention can be achieved when the actuating lever 15 is a plate member or the actuating lever 15 has an appropriate bent portion.

What is claimed is:

1. A wiper device comprising:
a linking member to which a driving force is transmitted via a wiper motor;
a rotating shaft fastened to the linking member;
a lever portion, one end of which is fastened to the rotating shaft, wherein the lever portion is a plate member laid down in a plane in which the lever portion is rotated; and
a wiper arm coupled with the other end of the lever member.

2. A wiper device comprising:
a linking member to which a driving force is transmitted via a wiper motor;
a rotating shaft fastened to the linking member;
a lever portion, one end of which is fastened to the rotating shaft, wherein the lever portion has a bent portion which is bent toward an axis of the rotating shaft; and
a wiper arm coupled with the other end of the lever member.

3. A wiper device comprising:
a linking member to which a driving force is transmitted via a wiper motor;
a rotating shaft fastened to the linking member;
a lever portion, one end of which is fastened to the rotating shaft, wherein the lever portion is a plate member laid down in a plane in which the lever portion is rotated, and the lever portion has a bent portion which is bent toward an axis of the rotating shaft; and
a wiper arm coupled with the other end of the lever member.

4. A wiper device according to claim 2, further comprising:
a coupling shaft disposed parallel to the rotating shaft, wherein the other end of the lever portion is fastened via the coupling shaft to the wiper arm, and is closer to the wiper arm than said one end in an axial direction of the coupling shaft.

5. A wiper device according to claim 3, further comprising:
a coupling shaft disposed parallel to the rotating shaft, wherein the other end of the lever portion is fastened via the coupling shaft to the wiper arm, and is closer to the wiper arm than said one end in an axial direction of the coupling shaft.
